(19) United States
(12) Patent Application Publication
(10) Pub. No.: US 2006/0289393 A1
(43) Pub. Date: Dec. 28, 2006

(54) Method of TIG braze-welding using an argon/helium/hydrogen mixture

(76) Inventors: Olivier Revel, Pierrelaye (FR); Andre Borne, Bessancourt (FR); Thomas Opderbecke, Saint-Ouen I'Aumone (FR)

Correspondence Address: Linda K. Russell;Suite 1800, 2700 Post Oak Blvd., Houston, TX, 77056, US

(21) Appl. No.: 11/442,085

(22) Filed: Aug. 21, 2006

(30) Foreign Application Priority Data
Jun. 6, 2005 (FR) 0551508

(51) Int. Cl. B23K 9/167; B23K 1/00

(52) U.S. Cl. 219/75; 219/129

(57) ABSTRACT

A method for the TIG braze-welding of one or more steel workpieces employing a TIG welding torch, a consumable wire and a shielding gas, characterized in that the shielding gas is a ternary gas mixture formed from helium, hydrogen and argon, containing less than 5% helium by volume; less than 1% hydrogen by volume; and argon for the balance. Application of the method to the welding of galvanized carbon steel sheet for automobiles.

This application claims the benefit of priority under 35 U.S.C. §119 (a) and (b) to French Application No. 0551508, filed Jun. 6, 2005, the entire contents of which are incorporated herein by reference.

### BACKGROUND

The present invention relates to a method for TIG braze-welding of both uncoated and galvanized carbon steels using a gas mixture containing argon, helium and hydrogen.

Gas-shielded TIG braze-welding or TIG brazing, and MAG, plasma or laser brazing methods are methods conventionally used in the field of automobile construction, in particular for joining certain vehicle body components together, such as boot or roof elements, in particular when there are stringent requirements in terms of bead appearance and sealing, especially in a flange-edge lap joint configuration.

The method of TIG welding with a filler wire or TIG braze-welding consists in joining metal workpieces together making a welded joint between them by the melting of a consumable filler wire by means of a TIG welding torch, that is to say a torch provided with a tungsten electrode supplied with electric current, and by using a suitable shielding gas.

In brazing, in theory, the base metal or that is to say the edges of the workpieces to be joined together, are not melted as the bond is provided by diffusion of the filler metal into the base metal, thereby making it possible in particular to join workpieces made of dissimilar metals or of the same metal but of different grades. However, in practice, in most arc brazing methods slight melting of the base metal is observed.

Persistently, it is quite difficult to increase the productivity and quality in TIG brazing of galvanized sheet for motor vehicles.

Several solutions based on a particular choice of gas have already been proposed for trying to solve this problem, but none has given complete satisfaction hitherto.

Thus, pure argon used as brazing gas has the disadvantage of resulting in insufficient wetting and lack of uniformity due to arc instabilities, this problem being manifest at high brazing speeds, that is to say typically above 50 cm/min.

To remedy this, binary mixtures formed from argon and hydrogen have been proposed, for example by document GB-A-2 038 687, since hydrogen helps to constrict and stabilize the arc, combined with a pool area reduction effect. However, it has been observed that such Ar/H₂ mixtures generate substantial porosity in the joint for hydrogen contents above about 2.5% by volume. Now, to improve the wetting and welding speed, a higher hydrogen content would be desirable.

Moreover, document EP-A-1 201 345 has proposed the use of argon/helium binary mixtures. This is because helium results in a higher arc voltage and therefore a higher welding energy. This results in greater wetting, but also larger deformations. Moreover, as these mixtures substantially increase the arc voltage, it becomes more difficult to join thin sheets together and, furthermore, larger deformations are observed and above all the welding speed is not improved compared with the use of argon/hydrogen binary mixtures.

In addition, argon/helium mixtures make arc striking more difficult, requiring this striking to be carried out in argon alone, before switching to the argon/helium mixture for welding, thereby complicating the method.

Furthermore, document EP-A-1 295 669 has proposed a ternary mixture containing argon, helium and hydrogen for TIG welding. However, this gas mixture has the drawback of generating too large a welding energy owing to the high helium and hydrogen content, thereby inducing excessively large deformations in the joints obtained. This gas is not recommended for carrying out braze-welding.

Finally, document U.S. Pat. No. 6,237,836 relates to a gas mixture containing argon, helium and hydrogen intended only for TIG welding of metals having a thermal conductivity lower than that of aluminium, such as high-alloy or low-alloy steels. Here again, this gas is not recommended for carrying out braze-welding.

The problem to be solved is therefore to alleviate the abovementioned problems and drawbacks, that is to say to propose a method of TIG braze-welding, using consumable filler wire, of uncoated and/or galvanized carbon steels making it possible to improve the productivity and the quality of the braze-welding of these steels, in particular for galvanized steel sheet intended for the motor-vehicle construction sector.

The solution of the invention is a method for the TIG braze-welding of one or more steel workpieces employing a welding torch, a consumable wire and a shielding gas, characterized in that the shielding gas is a ternary gas mixture formed from helium, hydrogen and argon, containing less than 5% helium by volume, less than 1% hydrogen by volume, and argon for the balance.

Depending on the case, the TIG braze-welding method of the invention may comprise one or more of the following features:
the gas mixture contains at least 0.1% helium by volume;
the gas mixture contains at least 0.4% helium by volume, preferably at least 0.5% helium by volume;
the gas mixture contains about 1% helium by volume;
the gas mixture contains less than 0.8% hydrogen by volume;
the gas mixture contains at least 0.1% hydrogen by volume;
the gas mixture contains about 0.5% hydrogen by volume;
braze-welding of several carbon steel workpieces is carried out;
braze-welding of several galvanized or zinc-plated carbon steel workpieces is carried out; and
the consumable wire is made of cupro-silicon (CuSi₃) or cupro-aluminium.

The invention also relates to a method of manufacturing automobile bodies, in which carbon steel workpieces are joined together by implementing a TIG braze-welding method with filler wire according to the invention, the torch preferably being carried by a robot arm.

The TIG braze-welding method of the invention therefore consists in joining metal workpieces together, particularly coated, especially galvanized or electrogalvanized, carbon steel workpieces, producing a welded joint between them by melting the consumable filler wire using a TIG arc welding torch.

When producing the welded joint, the aim is intentionally not to melt the edges of the workpieces to be joined together. The bond between the workpieces is normally obtained only by melting of the filler wire and subsequent solidification of the metal thus deposited. However, in certain cases there may be slight melting of said edges, but such melting is neither sought nor desired.

During the braze-welding operation, the braze-welding zone is protected with a ternary shielding gas mixture formed from helium, hydrogen and argon.

The preferred ternary mixture that can be used in the braze-welding method according to the invention essentially consists of argon to which 1% helium and 0.5% hydrogen are added (the percentages being by volume). However, gas mixtures having compositions close to this ternary mixture give satisfactory results.

Thus, it has been found that a minimum helium content of about 0.5% gives good results, but is a little more difficult to condition.

Likewise, a 5% helium content is acceptable, whereas a 10% helium content is unfavourable owing to the higher energy that it generates, thereby resulting in exaggerated deformations and to very substantial removal of the zinc layer covering the surface of zinc-coated steel sheet.

Table 1 below gives the results obtained in comparative trials of implementing a TIG braze-welding method aiming to demonstrate the influence of the various constituents of gas mixtures of variable compositions on the wetting, the welding speed, the amount of sputter and the porosity of the weld bead obtained on uncoated steel and galvanized steel workpieces.

The trial conditions employed for carrying out these trials are given in Table 2.

TABLE 1

| Composition of the gas | | |
|---|---|---|
| (in % by volume) | Uncoated steel | Galvanized steel |
| Ar + 0.5% H₂ + 1% He | Good | Good |
| Ar + 0.5% H₂ + 5% He | Acceptable | Acceptable |
| Ar + 0.5% H₂ + 10% He | Poor | / |
| Ar + 2.5% H₂ | Passable | Good |
| Ar | Poor | Passable |
| Ar + 5% H₂ + 20% He | Poor | Poor |

TABLE 2

| | | | Welding | Wire | Sheet |
|---|---|---|---|---|---|
| | Current (in | Voltage | speed | speed | thickness |
| Filler wire | A) | (in V) | (m/min) | (m/min) | (mm) |
| CuSi₃ | 140 | 13 | 1 | 4 | 1 |
| Ø 1 mm | | | | | |
| CuSi₃ | 170 | 13 | 2 | 5 | 1 |
| Ø 1 mm | | | | | |
| CuSi₃ | 155 | 10.5 | 1 | 3.5 | 2 |
| Ø 1.2 mm | | | | | |

The welding joints were of a flat lap joint configuration.

The wires used were of the CUSi₃ type with a diameter (Ø) of 1 or 1.2 mm depending on the trial.

The above Table 1 shows that only the gas mixtures according to the invention provide acceptable or good results both on uncoated steel and on galvanized steel, i.e. with a zinc coating.

In particular, the Ar+0.5H₂+1% He mixture has the best performance. The mixtures with higher proportions of helium have too high a welding energy, possibly leading to excess deformation.

The 2.5% hydrogen binary mixture runs the risk of generating porosity in the bead if the practice of sweeping is used for producing the joint.

Moreover, complementary trials were carried out with ternary gas mixtures formed from:
Trial A: 0.5% H₂+1% He+Ar (the balance)
Trial B: 0.5% H₂+20% He+Ar (the balance).

The welding conditions in these trials A and B were identical, namely: 120 A current; 11.5 V voltage; wire speed (Vf) 4 m/min; welding speed (Vs) 1 m/min; and gas flow rate 15 l/min. The filler wire used was of the CuSi₃ type.

A visual examination of the surface of the weld beads thus obtained (Trials A and B) revealed that, with 20% helium, a larger quantity of smoke was deposited in front of the bead and a trace of burnt zinc is visible behind the bead owing to the higher energy that a mixture containing more helium provides.

Furthermore, other trials were carried out with gas mixtures consisting of:
Trial C: 2.5% H₂+20% He+Ar (the balance);
Trial D: 5% He+Ar (the balance).

Trial D carried out with a gas of the ARCAL™ 31 type from L'Air Liquide was unsatisfactory owing to irregularities present in the bead.

The welding parameters used were then: 155 A current; 12.5 V voltage; 2.9 m/min wire speed; 1 m/min welding speed; 15 l/min gas flow rate. The filler wire used was of the CuSi₃ type.

Here, a visual examination of the bead surfaces showed irregularities in the absence of a minimum hydrogen content, that is to say in trial D.

A ternary mixture used in a method according to the invention achieves a beneficial effect on the welding speed, in particular a maximum welding speed of about 2 m/min, or even 3.5 m/min on electrogalvanized sheet, the wetting, and the appearance of the welding bead, makes it possible to avoid the problem of porosity in CuSi₃, and results in a less expensive gas mixture because of a low helium content (less than 5%), and easier striking.

The method of the invention can be used in particular for a robot welding installation as described in document EP-A-1 459 831.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for the TIG braze-welding of one or more steel workpieces employing a TIG welding torch, a consumable wire and a shielding gas, wherein the shielding gas is a ternary gas mixture formed from helium, hydrogen and argon, containing:
a) less than 5% helium by volume;
b) less than 1% hydrogen by volume; and
c) argon for the balance.

2. The method of claim 1, wherein the gas mixture contains at least 0.1% helium by volume.

3. The method of claim 1, wherein the gas mixture contains at least 0.4% helium by volume, preferably at least 0.5% helium by volume.

4. The method of claim 1, wherein the gas mixture contains about 1% helium by volume.

5. The method of claim 1, wherein the gas mixture contains less than 0.8% hydrogen by volume.

6. The method of claim 1, wherein the gas mixture contains at least 0.1% hydrogen by volume.

7. The method of claim 1, wherein the gas mixture contains about 0.5% hydrogen by volume.

8. The method of claim 1, wherein the ternary gas mixture consists of 0.45% to 0.55% hydrogen by volume, 0.95 to 1.05% helium by volume and argon for the balance.

9. The method of claim 1, wherein the ternary gas mixture consists of 0.5% hydrogen by volume, 1% helium by volume and argon for the balance.

10. The method of claim 1, wherein braze-welding of several carbon steel workpieces is carried out.

11. The method of claim 1, wherein braze-welding of several galvanized or zinc-plated carbon steel workpieces is carried out.

12. The method of claim 1, wherein the consumable wire is made of cupro-silicon (CuSi₃) or cupro-aluminium.

13. Method for manufacturing automobile bodies in which carbon steel workpieces are joined together by implementing a TIG braze-welding method with filler wire of claim 1.

14. Manufacturing method of claim 13, wherein the welding torch is carried by a robot arm.
